(19) United States
(12) Patent Application Publication
(10) Pub. No.: US 2020/0029772 A1
(43) Pub. Date: Jan. 30, 2020

(54) Managing Cleaning Robot Behavior

(71) Applicant: QUALCOMM Incorporated, San Diego, CA (US)

(72) Inventors: Daniel Warren MELLINGER, III, Philadelphia, PA (US); Stephen Marc CHAVES, Philadelphia, PA (US); Michael Joshua SHOMIN, Philadelphia, PA (US); Matthew Hyatt TURPIN, Waltham, MA (US); John Anthony DOUGHERTY, Philadelphia, PA (US); Ross Eric KESSLER, Philadelphia, PA (US); Jonathan Paul DAVIS, Philadelphia, PA (US); Travis VAN SCHOYCK, Princeton, NJ (US)

(21) Appl. No.: 16/043,635

(22) Filed: Jul. 24, 2018

(51) Int. Cl. A47L 11/40; A47L 9/28; G05D 1/00; G05D 1/02

(52) U.S. Cl. CPC A47L 11/4011; A47L 9/2815; A47L 9/2894; G05D 1/0088; G05D 2201/0215; A47L 2201/04; A47L 2201/06; G05D 2201/0203; G05D 1/0219

(57) ABSTRACT

Various embodiments include processing devices and methods for managing cleaning robot behavior. In some embodiments, a processor of the cleaning robot may obtain information about one or more cleaning operations in one or more locations of a structure. The processor may analyze the information about the one or more cleaning operations in the one or more locations. The processor may determine one or more cleaning parameters for the cleaning robot based on the analysis of the information about the one or more cleaning operations. Processor may generate an instruction for the cleaning robot to schedule an operation of the cleaning robot based on the one or more cleaning parameters. The processor may execute the generated instruction to perform the operation of the cleaning robot.

### BACKGROUND

Autonomous and semiautonomous robotic devices are being developed for a wide range of applications. One such application involves robotic cleaning devices, or cleaning robots. Early cleaning robots were robotic vacuum cleaners that had various problems including colliding with objects and leaving areas uncleaned. More sophisticated cleaning robots have been developed since that time. For example, cleaning robots may be programmed to clean on a predetermined schedule, such as at certain dates and times. However, such cleaning robots blindly follow their cleaning schedule, and are unable to dynamically adapt their cleaning activities to environmental conditions.

### SUMMARY

Various aspects include methods that may be implemented on a processor of a cleaning robot for managing cleaning behavior by a cleaning robot Various aspects may include obtaining, by a processor of a cleaning robot, information about one or more cleaning operations performed by the cleaning robot in one or more locations of a structure, analyzing, by the processor, the information about the one or more cleaning operations in the one or more locations, determining, by the processor, one or more cleaning parameters for the cleaning robot based on the analysis of the information about the one or more cleaning operations, generating, by the processor, an instruction to schedule an operation of the cleaning robot based on the one or more cleaning parameters, and executing, by the processor, the generated instruction to perform the operation of the cleaning robot.

In some aspects, determining the one or more cleaning parameters for the cleaning robot based on the analysis of the information about the one or more cleaning operations may include determining, by the processor, one or more physical characteristics of the one or more locations of the structure. In some aspects, determining the one or more cleaning parameters for the cleaning robot based on the analysis of the information about the one or more cleaning operations may include determining, by the processor, a type of cleaning operations performed by the cleaning robot. In some aspects, determining the one or more cleaning parameters for the cleaning robot based on the analysis of the information about the one or more cleaning operations may include determining, by the processor, an intensity of cleaning operations performed by the cleaning robot.

In some aspects, determining the one or more cleaning parameters for the cleaning robot based on the analysis of the information about the one or more cleaning operations may include determining, by the processor, a frequency of cleaning operations performed by the cleaning robot. In some aspects, generating an instruction for the cleaning robot to schedule an operation of the cleaning robot based on the one or more activity parameters may include determining, by the processor, a timing for the operation of the cleaning robot based on the one or more cleaning parameters.

In some aspects, generating an instruction for the cleaning robot to schedule an operation of the cleaning robot based on the one or more activity parameters may include determining, by the processor, a frequency for the operation of the cleaning robot based on the one or more cleaning parameters. In some aspects, generating an instruction for the cleaning robot to schedule an operation of the cleaning robot based on the one or more activity parameters may include determining, by the processor, one or more locations for the operation of the cleaning robot based on the one or more cleaning parameters. In some aspects, generating an instruction for the cleaning robot to schedule an operation of the cleaning robot based on the one or more activity parameters may include determining, by the processor, an intensity for the operation of the cleaning robot based on the one or more cleaning parameters.

Various aspects further include a cleaning robot having a processor configured with processor executable instructions to perform operations of any of the methods summarized above. Various aspects further include a processing device for use in a cleaning robot and configured to perform operations of any of the methods summarized above. Various aspects include a cleaning robot having means for performing functions of any of the methods summarized above. Various aspects include a non-transitory processor-readable storage medium having stored thereon processor-executable instructions configured to cause a processor of a cleaning robot to perform operations of any of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a cleaning robot operating within a communication system according to various embodiments.

FIG. 2 is a component block diagram illustrating components of a cleaning robot according to various embodiments.

FIG. 3 is a component block diagram illustrating a processing device suitable for use in cleaning robots implementing various embodiments.

FIG. 4 is a process flow diagram illustrating a method of managing cleaning robot behavior according to various embodiments.

FIG. 5 is a process flow diagram illustrating a method of managing cleaning robot behavior according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include methods that may be implemented on a processor of a cleaning robot that enable the cleaning robot to dynamically adapt autonomous or semiautonomous cleaning behaviors based on information obtained from sources external to the cleaning robot.

As used herein, the term “cleaning robot” refers to one of various types of devices including an onboard processing device configured to provide some autonomous or semi-autonomous capabilities. Various embodiments may be used with a variety of propulsion mechanisms, body designs, and component configurations, and may be configured to perform operations in a variety of environments, including airborne cleaning robots, and water-borne cleaning robots and/or some combination thereof A cleaning robot may be autonomous including an onboard processing device configured to maneuver and/or navigate while controlling cleaning functions of the cleaning robot without remote operating instructions. In embodiments in which the cleaning robot is semi-autonomous, the cleaning robot may include an onboard processing device configured to receive some information or instructions, such as from a human operator (e.g., via a remote computing device), and autonomously maneuver and/or navigate while controlling cleaning functions of the cleaning robot consistent with the received information or instructions. A cleaning robot may include a variety of components that may perform a variety of cleaning functions. Various embodiments may be performed by or adaptable to a wide range of smart cleaning appliances, including smart dishwashers, washing machines, clothing dryers, garbage collectors/emptiers, and other suitable smart cleaning appliances. For conciseness, term “cleaning robot” will be used herein.

Conventional cleaning robots may be programmed to clean on a predetermined schedule, such as at certain dates and times. However, such cleaning robots blindly follow their cleaning schedule, and are unable to dynamically adapt their cleaning activities to environmental conditions and presence, actions and/or plans of humans.

Various embodiments provide methods, and cleaning robot management systems configured to perform the methods of managing cleaning robot behavior to improve the effectiveness of cleaning operations and/or reduce interference with humans. Various embodiments enable a processor of a cleaning robot to dynamically adapt autonomous or semiautonomous behavior of the cleaning robot based upon information received or obtained from sources external to the cleaning robot about the environment in which it operates as well as one or more cleaning operations performed by the cleaning robot. Various embodiments improve the operation of the cleaning robot by enabling the processor of the cleaning robot to dynamically adjust a date, time, a frequency, a location, and other suitable parameters of one or more operations of the cleaning robot based on an analysis by the processor of the cleaning robot of the information determined by the cleaning robot to increase the cleaning robot's effectiveness and efficiency of operation. Various embodiments improve the operation of the cleaning robot by enabling the processor of the cleaning robot to draw inferences based on an analysis of the information learned by the cleaning robot (e.g., the information gathered and analyzed by the cleaning robot), and enabling the processor of the cleaning robot to dynamically adjust one or more aspects of operations of the cleaning robot (including scheduling parameters) based on the determined inferences.

In some embodiments, the processor of the cleaning robot may perform one or more cleaning operations in one or more locations of the structure. In some embodiments, the cleaning robot may perform cleaning operations including dusting, sweeping, vacuuming, mopping, polishing, dispensing a cleaning fluid, and other suitable cleaning operations. In some embodiments, the processor of the cleaning robot may obtain information about the one or more cleaning operations, e.g., during or after their performance by the cleaning robot. In some embodiments, the obtained information may include characteristics of the cleaning operations including activities performed, timing, duration, location, intensity of cleaning operations, frequency of cleaning operations, and other suitable characteristics of the cleaning operations. In some embodiments, the processor of the cleaning robot may analyze the information about the one or more cleaning operations in the one or more locations. In some embodiments, the processor of the cleaning robot may employ one or more analysis processes to analyze the information about the cleaning operation(s), such as one or more machine learning techniques.

In some embodiments, based on the analysis of the information about the one or more cleaning operations, the processor may determine one or more cleaning parameters for the cleaning robot. In some embodiments, the cleaning parameters may include one or more physical characteristics of the location(s) in which the robot performed the cleaning operations. For example, physical characteristics of the one or more locations may include a size of the location, a shape of the location, objects encountered while cleaning the location, materials encountered while cleaning the location (e.g., carpet, hardwood floors, area rugs, and other similar materials), and other physical characteristics of the one or more locations.

In some embodiments, based on the analysis of the information about the one or more cleaning operations, the processor may determine a type of cleaning operations to be performed. In some embodiments, the type of cleaning operations may include vacuuming, dusting, sweeping, mopping, polishing, dispensing a cleaning fluid, or another suitable cleaning operation type.

In some embodiments, based on the analysis of the information about the one or more cleaning operations to be performed, the processor may determine an intensity of the cleaning operations to be performed. For example, the processor may determine a level of intensity of the cleaning operations required by conditions of the location. In some embodiments, the processor may determine a quantifiable (e.g., numerical or relative) level of intensity of the cleaning operations. In some embodiments, the processor may determine whether the level of intensity of the cleaning operations exceeds one or more thresholds.

In some embodiments, based on the analysis of the information about the one or more cleaning operations, the processor may determine a frequency of the cleaning operations to be performed. In some embodiments, the processor may determine the frequency of the cleaning operations to be performed based on a number of cleaning operations performed during a time period. In some embodiments, the processor may determine the frequency of the cleaning operations based on a number of repetitions of one or more cleaning operations in the location.

In some embodiments, based on the determined cleaning parameter(s), the processor of the cleaning robot may generate an instruction for the cleaning robot to schedule an operation of the cleaning robot. In some embodiments, the processor may determine a timing to schedule the operation of the cleaning robot based on the one or more cleaning parameters. The timing of the operation of the cleaning robot may include one or more of a start time, stop time, a duration, or another suitable timing parameter for the operation of the cleaning robot. In some embodiments, the processor may determine a frequency to schedule the operation of the cleaning robot based on the one or more cleaning parameters. In some embodiments, the processor may determine one or more locations of the structure to schedule the operation of the cleaning robot based on the one or more activity parameters.

In some embodiments, the processor of the cleaning robot may execute the generated instruction to perform the operation of the cleaning robot.

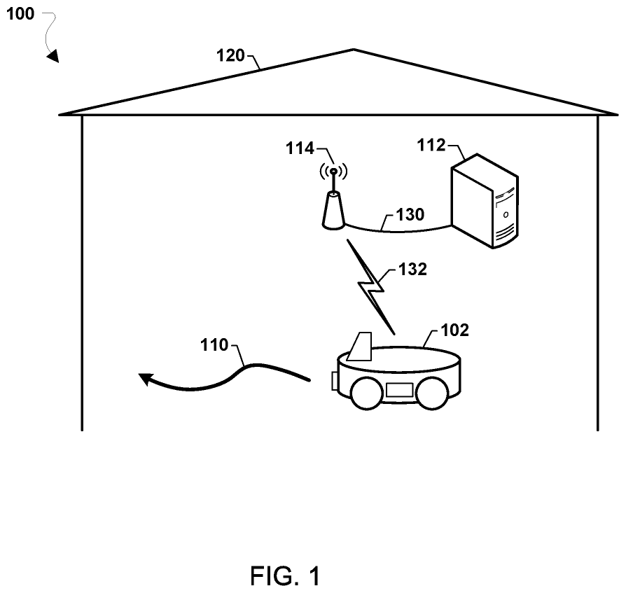

Various embodiments may be implemented within a cleaning robot operating within a variety of communication systems 100, an example of which is illustrated in FIG. 1. With reference to FIG. 1, the communication system 100 may include a cleaning robot 102 and a hub device 112. The communication system 100 may be located in and around a structure 120. The structure 120 may include one or more locations, which may be discrete locations in and around the structure, as well as sub-locations within discrete locations (e.g., rooms, areas within rooms, doorways, hallways, foyers, porches, patios, and other suitable locations).

The hub device 112 may include a wireless communications device, such as a wireless access point 114, that enables wireless communications with the cleaning robot 102 over a wireless communication link 132. The hub device 112 may communicate with the wireless communication device 112 over a wired or wireless communication link 130. In various embodiments, the hub device 112 may enable wireless communications with one or more other devices, such as a wide variety of smart home devices and Internet of Things (IoT) devices. Such additional devices are not illustrated for clarity.

The wireless communication link 132 may include a plurality of carrier signals, frequencies, or frequency bands, each of which may include a plurality of logical channels. Each of the wireless communication links may utilize one or more radio access technologies (RATs). Examples of RATs that may be used in one or more of the various wireless communication link 132 include an Institute of Electrical and Electronics Engineers (IEEE) 802.15.4 protocol (such as Thread, ZigBee, and Z-Wave), any of the Institute of Electrical and Electronics Engineers (IEEE) 16.11 standards, or any of the IEEE 802.11 standards, the Bluetooth® standard, Bluetooth Low Energy (BLE), 6LoWPAN, LTE Machine-Type Communication (LTE MTC), Narrow Band LTE (NB-LTE), Cellular IoT (CIoT), Narrow Band IoT (NB-IoT), BT Smart, Wi-Fi, LTE-U, LTE-Direct, MuLTEfire, as well as relatively extended-range wide area physical layer interfaces (PHYs) such as Random Phase Multiple Access (RPMA), Ultra Narrow Band (UNB), Low Power Long Range (LoRa), Low Power Long Range Wide Area Network (LoRaWAN), and Weightless. Further examples of RATs that may be used in one or more of the various wireless communication links within the communication system 100 include 3GPP Long Term Evolution (LTE), 3G, 4G, 5G, Global System for Mobility (GSM), GSM/General Packet Radio Service (GPRS), Enhanced Data GSM Environment (EDGE), Code Division Multiple Access (CDMA), frequency division multiple access (FDMA), time division multiple access (TDMA), Wideband Code Division Multiple Access (W-CDMA), Worldwide Interoperability for Microwave Access (WiMAX), Time Division Multiple Access (TDMA), and other mobile telephony communication technologies cellular RATs, Terrestrial Trunked Radio (TETRA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, and other mobile telephony communication technologies cellular RATs or other signals that are used to communicate within a wireless, cellular or Internet of Things (IoT) network or further implementations thereof.

In various embodiments, the cleaning robot 102 may perform one or more cleaning operations 110 in and around the structure 120. In some embodiments, the cleaning robot 102 may navigate to one or more locations of the structure 120, and may perform one or more cleaning operations in the one or more locations. In some embodiments, the cleaning robot 102 may dynamically manage the scheduling and performance of various cleaning operations based on information obtained by the cleaning robot during and/or after the performance of one or more cleaning operations in one or more locations. In some embodiments, the cleaning robot may analyze the information about the one or more cleaning operations in the one or more locations, and based on the analysis of such information the cleaning robot may dynamically manage the scheduling and performance of its cleaning operations as further described below.

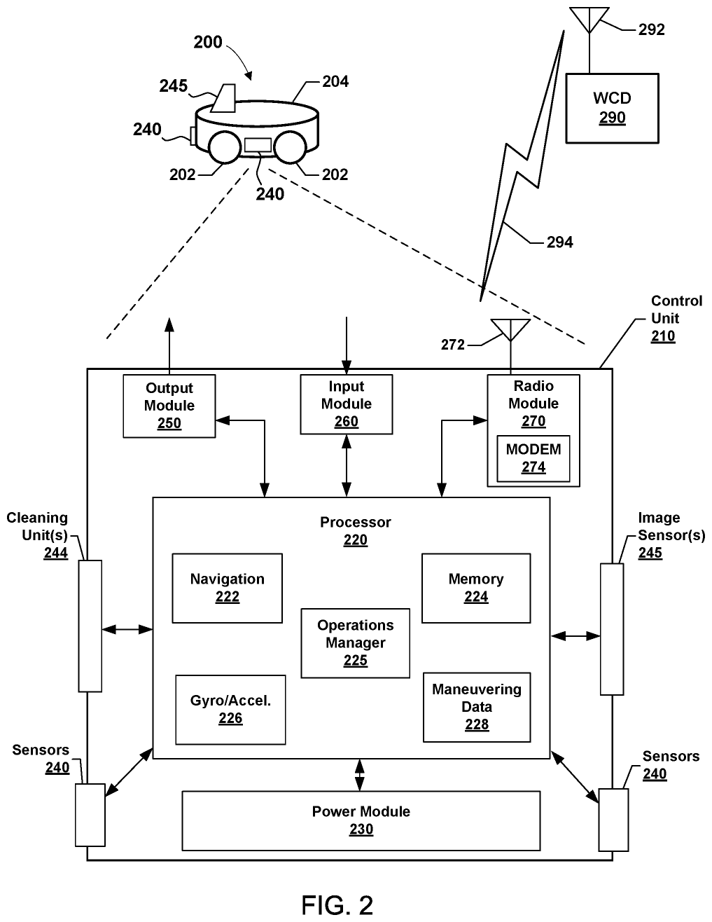

FIG. 2 illustrates an example cleaning robot 200 of a ground vehicle design that utilizes one or more wheels 202 driven by corresponding motors to provide locomotion to the cleaning robot 200. The cleaning robot 200 is illustrated as an example of a cleaning robot that may utilize various embodiments, but is not intended to imply or require that the claims are limited to wheeled ground cleaning robots. For example, various embodiments may be used with a variety of propulsion mechanisms, body designs, and component configurations, and may be configured to perform operations in a variety of environments, including cleaning robots that maneuver at least partially by flying, and water-borne cleaning robots (e.g., pool cleaning robots).

With reference to FIGS. 1 and 2, the cleaning robot 200 may be similar to the cleaning robot 102. The cleaning robot 200 may include a number of wheels 202 and a body 204. The frame 204 may provide structural support for the motors and their associated wheels 202. For ease of description and illustration, some detailed aspects of the cleaning robot 200 are omitted such as wiring, frame structure interconnects, or other features that would be known to one of skill in the art. While the illustrated cleaning robot 200 has wheels 202, this is merely exemplary and various embodiments may include any variety of components to provide propulsion and maneuvering capabilities, such as treads, paddles, skids, or any combination thereof or of other components.

The cleaning robot 200 may further include a control unit 210 that may house various circuits and devices used to power and control the operation of the cleaning robot 200. The control unit 210 may include a processor 220, a power module 230, sensors 240, one or more cleaning units 244, one or more image sensors 245, an output module 250, an input module 260, and a radio module 270.

The processor 220 may be configured with processor-executable instructions to control travel and other operations of the cleaning robot 200, including operations of various embodiments. The processor 220 may include or be coupled to a navigation unit 222, a memory 224, an operations management unit 225, a gyro/accelerometer unit 226, and a maneuvering data module 228. The processor 220 and/or the navigation unit 222 may be configured to communicate with a server through a wireless communication link to receive data useful in navigation, provide real-time position reports, and assess data.

The maneuvering data module 228 may be coupled to the processor 220 and/or the navigation unit 222, and may be configured to provide travel control-related information such as orientation, attitude, speed, heading, and similar information that the navigation unit 222 may use for navigation purposes. The gyro/accelerometer unit 226 may include an accelerometer, a gyroscope, an inertial sensor, an inertial measurement unit (IMU), or other similar sensors. The maneuvering data module 228 may include or receive data from the gyro/accelerometer unit 226 that provides data regarding the orientation and accelerations of the cleaning robot 200 that may be used in navigation and positioning calculations, as well as providing data used in various embodiments for processing images.

The processor 220 may further receive additional information from one or more image sensors 245 (e.g., a camera) and/or other sensors 240. In some embodiments, the image sensor(s) 245 may include an optical sensor capable of infrared, ultraviolet, and/or other wavelengths of light. Information from the one or more image sensors 245 may be used for navigation, as well as for providing information useful in controlling cleaning operations. For example, images of surfaces may be used by the processor 220 to determine a level or intensity of cleaning operations (e.g., brush speed or pressure) to apply to a given location.

The processor 220 may further receive additional information from one or more other sensors 240. Such sensors 240 may also include a wheel rotation sensor, a radio frequency (RF) sensor, a barometer, a thermometer, a humidity sensor, a chemical sensor (e.g., capable of sensing a chemical in a solid, liquid, and/or gas state), a vibration sensor, a sonar emitter/detector, a radar emitter/detector, a microphone or another acoustic sensor, contact or pressure sensors (e.g., that may provide a signal that indicates when the cleaning robot 200 has made contact with a surface), and/or other sensors that may provide information usable by the processor 220 to determine environmental conditions, as well as for movement operations, navigation and positioning calculations, and other suitable operation.

The power module 230 may include one or more batteries that may provide power to various components, including the processor 220, the sensors 240, the cleaning unit(s) 244, the image sensor(s) 245, the output module 250, the input module 260, and the radio module 270. In addition, the power module 230 may include energy storage components, such as rechargeable batteries. The processor 220 may be configured with processor-executable instructions to control the charging of the power module 230 (i.e., the storage of harvested energy), such as by executing a charging control algorithm using a charge control circuit. Alternatively or additionally, the power module 230 may be configured to manage its own charging. The processor 220 may be coupled to the output module 250, which may output control signals for managing the motors that drive the rotors 202 and other components.

The cleaning robot 200 may be controlled through control of the individual motors of the rotors 202 as the cleaning robot 200 progresses toward a destination. The processor 220 may receive data from the navigation unit 222 and use such data in order to determine the present position and orientation of the cleaning robot 200, as well as the appropriate course towards the destination or intermediate sites. In various embodiments, the navigation unit 222 may include a global navigation satellite system (GNSS) receiver system (e.g., one or more global positioning system (GPS) receivers) enabling the cleaning robot 200 to navigate using GNSS signals. Alternatively or in addition, the navigation unit 222 may be equipped with radio navigation receivers for receiving navigation beacons or other signals from radio nodes, such as navigation beacons (e.g., very high frequency (VHF) omni-directional range (VOR) beacons), access points that use any of a number of short range RATs (e.g., Wi-Fi, Bluetooth, Zigbee, Z-Wave, etc.), cellular network sites, radio stations, remote computing devices, other cleaning robots, etc.

The cleaning units 244 may include one or more of a variety of devices that enable the cleaning robot 200 to perform cleaning operations proximate to the cleaning robot 200 in response to commands from the control unit 210. In various embodiments, the cleaning units 244 may include brushes, vacuums, wipers, scrubbers, dispensers for cleaning solution, and other suitable cleaning mechanisms.

The radio module 270 may be configured to receive navigation signals, such as signals from aviation navigation facilities, etc., and provide such signals to the processor 220 and/or the navigation unit 222 to assist in cleaning robot navigation. In various embodiments, the navigation unit 222 may use signals received from recognizable RF emitters (e.g., AM/FM radio stations, Wi-Fi access points, and cellular network base stations) on the ground.

The radio module 270 may include a modem 274 and a transmit/receive antenna 272. The radio module 270 may be configured to conduct wireless communications with a variety of wireless communication devices (e.g., a wireless communication device (WCD) 290), examples of which include a wireless telephony base station or cell tower (e.g., a base station), a network access point (e.g., a wireless access point 114), a beacon, a smartphone, a tablet, or another computing device with which the cleaning robot 200 may communicate. The processor 220 may establish a bi-directional wireless communication link 294 via the modem 274 and the antenna 272 of the radio module 270 and the wireless communication device 290 via a transmit/receive antenna 292. In some embodiments, the radio module 270 may be configured to support multiple connections with different wireless communication devices using different radio access technologies.

In various embodiments, the wireless communication device 290 may be connected to a server through intermediate access points. In an example, the wireless communication device 290 may be a server of a cleaning robot operator, a third party service, or a site communication access point. The cleaning robot 200 may communicate with a server through one or more intermediate communication links, such as a wireless telephony network that is coupled to a wide area network (e.g., the Internet) or other communication devices. In some embodiments, the cleaning robot 200 may include and employ other forms of radio communication, such as mesh connections with other cleaning robots or connections to other information sources.

The processor 220 may receive information and instructions generated by the operations manager 225 to schedule and control one or more operations of the cleaning robot 200, including various cleaning operations. In some embodiments, the operations manager 225 may receive information via the communication link 294 from one or more sources external to the cleaning robot 200.

In various embodiments, the control unit 210 may be equipped with an input module 260, which may be used for a variety of applications. For example, the input module 260 may receive images or data from an onboard camera or sensor, or may receive electronic signals from other components (e.g., a payload).

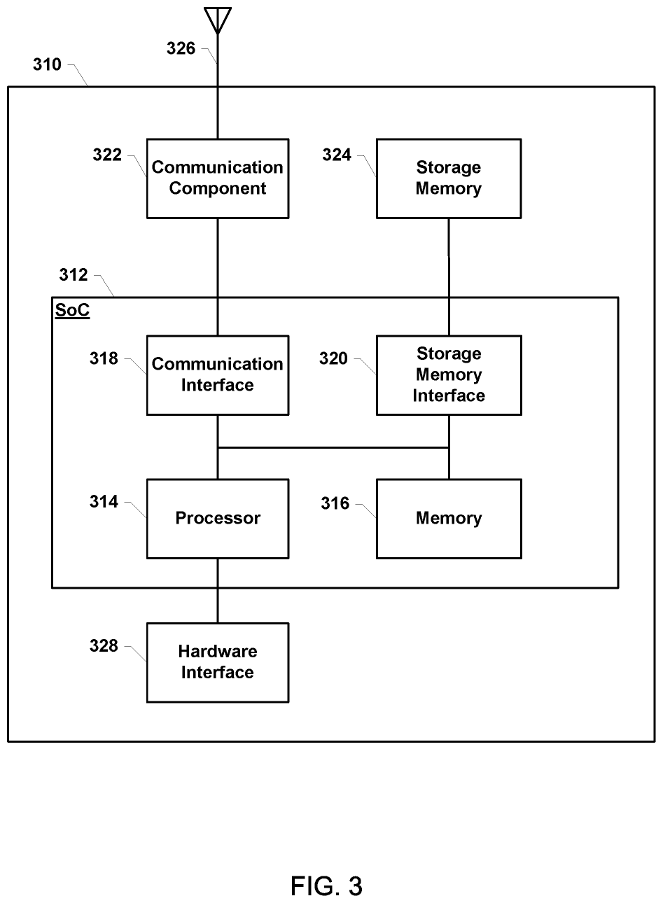

While various components of the control unit 210 are illustrated in FIG. 2 as separate components, some or all of the components (e.g., the processor 220, the output module 250, the radio module 270, and other units) may be integrated together in a single processing device 310, an example of which is illustrated in FIG. 3.

With reference to FIGS. 1-3, the processing device 310 may be configured to be used in a cleaning robot (e.g., the cleaning robot 102 and 200) and may be configured as or including a system-on-chip (SoC) 312. The SoC 312 may include (but is not limited to) a processor 314, a memory 316, a communication interface 318, and a storage memory interface 320. The processing device 310 or the SoC 312 may further include a communication component 322, such as a wired or wireless modem, a storage memory 324, an antenna 326 for establishing a wireless communication link, and/or the like. The processing device 310 or the SoC 312 may further include a hardware interface 328 configured to enable the processor 314 to communicate with and control various components of a cleaning robot. The processor 314 may include any of a variety of processing devices, for example any number of processor cores.

The term “system-on-chip” (SoC) is used herein to refer to a set of interconnected electronic circuits typically, but not exclusively, including one or more processors (e.g., 314), a memory (e.g., 316), and a communication interface (e.g., 318). The SoC 312 may include a variety of different types of processors 314 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 312 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 312 may include one or more processors 314. The processing device 310 may include more than one SoC 312, thereby increasing the number of processors 314 and processor cores. The processing device 310 may also include processors 314 that are not associated with an SoC 312 (i.e., external to the SoC 312). Individual processors 314 may be multicore processors. The processors 314 may each be configured for specific purposes that may be the same as or different from other processors 314 of the processing device 310 or SoC 312. One or more of the processors 314 and processor cores of the same or different configurations may be grouped together. A group of processors 314 or processor cores may be referred to as a multi-processor cluster.

The memory 316 of the SoC 312 may be a volatile or non-volatile memory configured for storing data and processor-executable instructions for access by the processor 314. The processing device 310 and/or SoC 312 may include one or more memories 316 configured for various purposes. One or more memories 316 may include volatile memories such as random access memory (RAM) or main memory, or cache memory.

Some or all of the components of the processing device 310 and the SoC 312 may be arranged differently and/or combined while still serving the functions of the various aspects. The processing device 310 and the SoC 312 may not be limited to one of each of the components, and multiple instances of each component may be included in various configurations of the processing device 310.

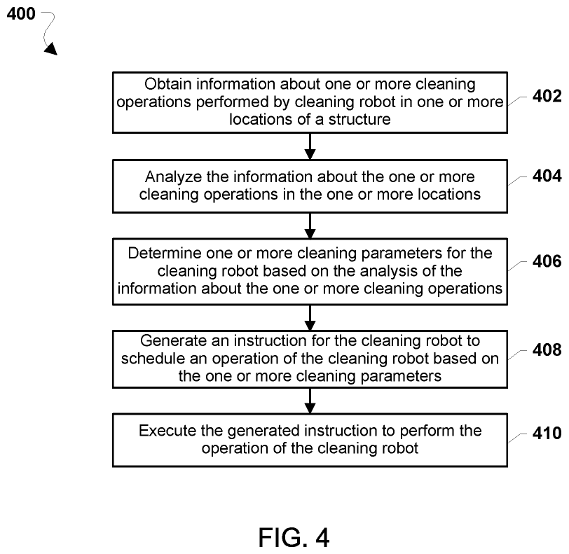

FIG. 4 illustrates a method 400 of managing cleaning robot behavior according to various embodiments. With reference to FIGS. 1-4, a processor of a cleaning robot (e.g., the processor 220, the processing device 310, the SoC 312, and/or the like) and hardware components and/or software components of the cleaning robot may obtain information from one or more sources external to the cleaning robot and dynamically schedule and perform various cleaning robot operations.

In block 402, the processor of the cleaning robot may obtain information about one or more cleaning operations performed by the cleaning robot in one or more locations of the structure. In some embodiments, the cleaning robot may perform cleaning operations including dusting, sweeping, vacuuming, mopping, polishing, dispensing a cleaning fluid, and other suitable cleaning operations. In some embodiments, the processor of the cleaning robot may obtain information about the one or more cleaning operations, e.g., during or after their performance by the cleaning robot. In some embodiments, the obtained information may include characteristics of the cleaning operations including activities performed, timing, duration, location, intensity of cleaning operations, frequency of cleaning operations, and other suitable characteristics of the cleaning operations.

In some embodiments, the processor of the cleaning robot may obtain information about the one or more locations where cleaning operations were performed. For example, the processor may receive information from sensors of the cleaning robot (e.g., the image sensors 245 and/or the other sensors 240) about environmental conditions, locations of objects, the composition of materials (e.g., rugs, hardwood floors, furniture materials, wallpaper, draperies, and the like), and other suitable information about the one or more locations. In some embodiments, the processor of the cleaning robot may obtain such information about the one or more locations from a sensor that is external to the cleaning robot, such as another sensor in the location and/or in the structure (e.g., a camera, thermostat, humidistat, a heating, ventilation and air conditioning system, or another suitable information source).

In some embodiments, the processor of the cleaning robot may accumulate the obtained information over time, and may generate and store in memory one or more data structures to store the information about the one or more cleaning operations.

In block 404, the processor of the cleaning robot may analyze the information about the one or more cleaning operations in the one or more locations. In some embodiments, the processor of the cleaning robot may employ one or more analysis processes to analyze the information about the cleaning operation(s), such as one or more machine learning techniques. For example, the processor may apply one or more machine learning techniques to analyze the information about the cleaning operation(s). In some embodiments, the processor may accumulate one or more analyses of the information over time. In various embodiments, the processor of the cleaning robot may store the analyzed information and/or one or more analyses in the one or more generated data structures.

In some embodiments, the processor may determine physical characteristics of the one or more locations where the cleaning operations were performed based on the analyzed information. For example, the processor may determine based on information from a wheel sensor, pressure sensor, wheel rotation sensor, and the like that the cleaning robot can travel quickly or easily over a surface, or that there is little resistance to motion of the cleaning robot. Based on this information, the processor may determine that a floor surface is, for example, hardwood or tile. As another example, the processor may determine one or more conditions or aspects of a location based on an analysis of image information from a cleaning robot camera.

In some embodiments, the processor may analyze information obtained from a sensor of the cleaning robot in combination with, or supplemental to, information obtained from a sensor external to the cleaning robot. For example, the processor of the cleaning robot may augment the analysis of information the cleaning robot's sensor(s) with an analysis of information obtained from one or more sensors external to the cleaning robot.

In some embodiments, the processor of the cleaning robot may provide sensor information to another device (e.g., the hub device 112) processing, or to assist with the processing of the sensor information. In some embodiments, the other device may receive sensor information directly from an external sensor (i.e., external to the cleaning robot). In some embodiments, a processor of the other device may perform a certain level of analysis of the sensor information (from the cleaning robot's sensor(s) and/or the external sensor(s)) and provide the results of the analysis to the processor of the cleaning robot. For example, the processor of the cleaning robot may send sensor information to the hub device and/or the hub device may receive one or more images from an external sensor, and a processor of the hub device may analyze the sensor information. For example, the processor of hub device may identify one or more objects, types of objects, materials, conditions, or other suitable information based on the received sensor information. In some embodiments, the processor of the hub device may provide the results of its analysis (i.e., the identification of the one or more objects, types of object, materials, conditions, and the like) to the cleaning robot, and the processor of the cleaning robot may incorporate the analytical results from the hub device into the cleaning robot processor's analysis of the sensor information.

In block 406, the processor of the cleaning robot may determine one or more cleaning parameters for the cleaning robot based on the analysis of the information about the one or more cleaning operations. In some embodiments, the cleaning parameters may include one or more physical characteristics of the location(s) in which the robot performed the cleaning operations. For example, physical characteristics of the one or more locations may include a size, a shape, materials encountered (e.g., carpet, hardwood floors, area rugs, and other similar materials), and other physical characteristics of the one or more locations. In some embodiments, the processor may determine a type of cleaning operations performed. In some embodiments, the processor may determine an intensity of the cleaning operations performed. In some embodiments, the processor may determine a frequency of the cleaning operations performed. In some embodiments, the processor of the cleaning robot may determine the one or more cleaning parameters in the location based on the analysis of the sensor information of the location from the external sensor(s) and based on an analysis of sensor information obtained with a sensor of the cleaning robot.

In block 408, the processor of the cleaning robot may generate an instruction for the cleaning robot to schedule an operation of the cleaning robot based on the one or more cleaning parameters. In some embodiments, the processor may determine a timing for operation of the cleaning robot based on the one or more activity parameters. In some embodiments, the timing of the operation of the cleaning robot may include one or more of a start time, stop time, a duration, or another suitable timing parameter for the operation of the cleaning robot. In some embodiments, the processor may determine a frequency for operation of the cleaning robot based on the one or more activity parameters. In some embodiments, the frequency may include a number of times that the cleaning robot is scheduled to perform one or more cleaning operations. In some embodiments, the frequency may include a number of repetitions of one or more cleaning operations to be performed (e.g., in a location, or at a sub-location within a location). In some embodiments, the processor may determine one or more locations (or areas, or sub-locations within a location) of the structure for operation of the cleaning robot based on the one or more activity parameters.

In block 410, the processor may execute the generated instruction to perform the operation of the cleaning robot.

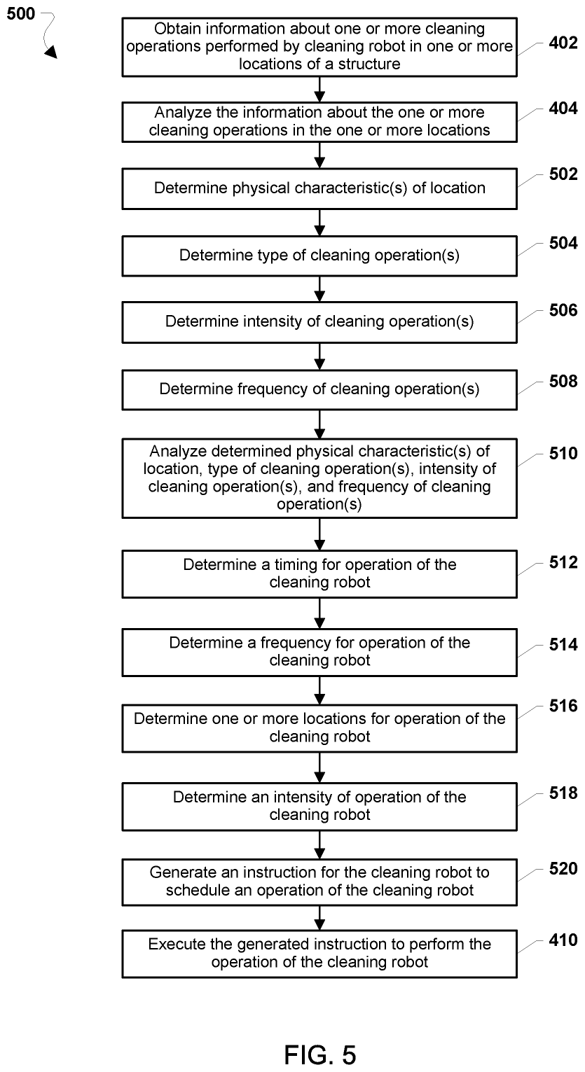

FIG. 5 illustrates a method 500 of managing cleaning robot behavior according to various embodiments. With reference to FIGS. 1-5, a processor of a cleaning robot (e.g., the processor 220, the processing device 310, the SoC 312, and/or the like and hardware components and/or software components of the cleaning robot may obtain information from one or more sources external to the cleaning robot and dynamically schedule and perform various cleaning robot operations. In blocks 402, 404, and 410, the processor of the cleaning robot may perform operations of like-numbered blocks of the method 400 as described.

In block 404, the processor of the cleaning robot may analyze the information about the one or more cleaning operations in the one or more locations, as described.

In block 502, the processor of the cleaning robot may determine one or more physical characteristics of the location(s) in which the robot performed the cleaning operations. In some embodiments, the processor may determine the one or more physical characteristics of the one or more locations based on the analysis of the information about the one or more cleaning operations in the one or more locations. For example, physical characteristics of the one or more locations may include a size, a shape, objects encountered (e.g., furniture, etc.) while cleaning the location, materials encountered (e.g., carpet, hardwood floors, area rugs, and other similar materials) while cleaning the location, and other physical characteristics of the one or more locations. In some embodiments, the physical characteristics of the location may include a material or arrangement of material that is potentially subject to being cleaned by the cleaning robot. Such material may include dirt, dust, mud, garbage, spilled solid or liquid, human or animal waste, or another material that would readily be understood as a type typically subject to being cleaned up (which may be referred to generally as a “mess”).

In block 504, the processor of the cleaning robot may determine a type of cleaning operation(s) performed based on the analysis of the information about the one or more cleaning operations. In some embodiments, the processor may determine the type of cleaning operation(s) based on the analysis of the information about the one or more cleaning operations in the one or more locations. In some embodiments, the type of cleaning operations may include vacuuming, dusting, sweeping, mopping, polishing, dispensing a cleaning fluid, or another suitable cleaning operation type. In some embodiments, the type of cleaning operations may include a combination of two or more cleaning operations.

In block 506, the processor of the cleaning robot may determine an intensity of the cleaning operation(s) performed based on the analysis of the information about the one or more cleaning operations. In some embodiments, the processor may determine the intensity of the cleaning operation(s) based on the analysis of the information about the one or more cleaning operations in the one or more locations. For example, the processor may determine a level of intensity of the cleaning operations required by conditions of the location. In some embodiments, the processor may determine a quantifiable (e.g., numerical or relative) level of intensity of the cleaning operations. In some embodiments, the processor may determine whether the level of intensity of the cleaning operations exceeds one or more thresholds. In some embodiments, the processor may determine the level of intensity of the cleaning operations based on a type of cleaning activities performed, a number of cleaning activities performed, a duration of cleaning activities performed, and other factors.

In block 508, the processor of the cleaning robot may determine a frequency of the cleaning operation(s) performed based on the analysis of the information about the one or more cleaning operations. In some embodiments, the processor may determine the frequency of the cleaning operation(s) based on the analysis of the information about the one or more cleaning operations in the one or more locations. In some embodiments, the processor may determine the frequency of the cleaning operations based on a number of cleaning operations performed during a time period. In some embodiments, the processor may determine the frequency of the cleaning operations based on a number of repetitions of one or more cleaning operations in the location. In some embodiments, the processor may determine a high level or frequency of activity, a low level or frequency of cleaning operations, and so forth. In some embodiments, the processor may quantify the determination of the frequency of the cleaning operations in the location based on, for example, a comparison of a number and/or frequency of cleaning operations or types of cleaning operations over a period of time to one or more thresholds.

In block 510, the processor of the cleaning robot may analyze the determined physical characteristic(s) of the location, the determined type of cleaning operation(s), the determined intensity of the cleaning operation(s), and the determined frequency of the cleaning operation(s). In some embodiments, the processor may generate and store in a memory one or more analyses of such determined information. In some embodiments, the processor may apply one or more machine learning techniques to the determined information to determine, for example, the rate at which a location becomes dirty, an amount of mess that typically accumulates at a location, a type of mess that typically accumulates in the location, and other cleaning-related conditions. In some embodiments, based on the analysis of the physical characteristic(s) of the location, the determined type of cleaning operation(s), the determined intensity of the cleaning operation(s), and/or the determined frequency of the cleaning operation(s), the processor may dynamically determine or adjust one or more aspects of cleaning operations performed by the cleaning robot.

In block 512, the processor of the cleaning robot may determine a timing for an operation of the cleaning robot. In some embodiments, the processor may determine the timing for the operation of the cleaning robot based on one or more of the physical characteristic(s) of the location, the determined type of cleaning operation(s), the determined intensity of the cleaning operation(s), and/or the determined frequency of the cleaning operation(s). In some embodiments, the processor may determine the timing for the operation of the cleaning robot based on the analysis of one or more of the physical characteristic(s) of the location, the determined type of cleaning operation(s), the determined intensity of the cleaning operation(s), and/or the determined frequency of the cleaning operation(s). In some embodiments, the timing may include a start time and/or a stop time of operation of the cleaning robot. In some embodiments, the timing may include a duration for performing the operation of the cleaning robot. The timing may further include other suitable timing parameters for the operation of the cleaning robot.

In block 514, the processor of the cleaning robot may determine a frequency for an operation of the cleaning robot. In some embodiments, the processor may determine the frequency for the operation of the cleaning robot based on one or more of the physical characteristic(s) of the location, the determined type of cleaning operation(s), the determined intensity of the cleaning operation(s), and/or the determined frequency of the cleaning operation(s). In some embodiments, the processor may determine the frequency for the operation of the cleaning robot based on the analysis of one or more of the physical characteristic(s) of the location, the determined type of cleaning operation(s), the determined intensity of the cleaning operation(s), and/or the determined frequency of the cleaning operation(s).

In block 516, the processor of the cleaning robot may determine one or more locations for an operation of the cleaning robot. In some embodiments, the processor may determine the location(s) for the operation of the cleaning robot based on one or more of the physical characteristic(s) of the location, the determined type of cleaning operation(s), the determined intensity of the cleaning operation(s), and/or the determined frequency of the cleaning operation(s). In some embodiments, the processor may determine the location(s) for the operation of the cleaning robot based on the analysis of one or more of the physical characteristic(s) of the location, the determined type of cleaning operation(s), the determined intensity of the cleaning operation(s), and/or the determined frequency of the cleaning operation(s).

In some embodiments, the processor may determine a timing for each of a plurality of determined locations for an operation of the cleaning robot (e.g., a start time, stop time, duration, frequency, or another suitable timing parameter). In some embodiments, the processor may determine a frequency for each of a plurality of determined locations for the operation of the cleaning robot (e.g., a start time, stop time, duration, frequency, or another suitable timing parameter).

In block 518, the processor of the cleaning robot may determine an intensity of the operation of the cleaning robot. In some embodiments, the processor may determine the intensity of the operation based on the one or more cleaning parameters. In some embodiments, the processor may determine the intensity of the operation location(s) for the operation of the cleaning robot based on the analysis of one or more of the physical characteristic(s) of the location, the determined type of cleaning operation(s), the determined intensity of the cleaning operation(s), and/or the determined frequency of the cleaning operation(s).

In some embodiments, the processor may determine the intensity of the operation in block 518 based on the analysis of the information about the one or more cleaning operations in the one or more locations. For example, the processor may determine the intensity of the operation based on the determined physical characteristic(s) of the location, the type of cleaning operation(s), the intensity of the observed cleaning operation(s), and the frequency of cleaning operation(s).

In some embodiments, the processor may determine the intensity of the operation in block 518 based on the determined timing, the determined frequency, and/or the one or more locations for operation of the cleaning robot (as well as, or in addition to the analysis of the information about the one or more cleaning operations in the one or more locations). For example, the cleaning robot may operate nominally in a power-saving type mode during normal up-keep cleaning in order to prolong battery life if significant cleaning is not expected to be required. However, based on the determined physical characteristic(s) of the location, the type of cleaning operation(s), the intensity of the observed cleaning operation(s), the frequency of cleaning operation(s), the determined timing, the determined frequency, and/or the one or more locations for operation of the cleaning robot, the processor may determine that a higher intensity cleaning operation (e.g., a higher-power, more intense cleaning mode) is appropriate to clean the area effectively.

In some embodiments, the intensity of the cleaning robot operation determined in block 518 may be a discrete parameter, such as a power-save mode vs. a high-power mode. In some embodiments, the intensity of the cleaning robot operation determined in block 518 may be within a range of intensities (e.g., in a range from 0 to 1, from 1 to 10, etc. in which the value is related to an intensity of the cleaning operation).

In some embodiments in block 518, the processor may determine two or more intensities of the cleaning robot operation or may vary the intensity of cleaning operations based on the determined physical characteristic(s) of the location, the type of cleaning operation(s), the intensity of the observed cleaning operation(s), the frequency of cleaning operation(s), the determined timing, the determined frequency, and/or the one or more locations for operation of the cleaning robot. Determining the intensity of the operation of the cleaning robot may enable the robot to perform one or more operations more effectively and efficiently by dynamically increasing or decreasing the operation of the cleaning robot. Determining the intensity of the operation may enable the cleaning robot to preserve stored power (e.g., battery charge) where possible. Determining the intensity of the operation may enable the cleaning robot to utilize cleaning materials and the like more efficiently by decreasing the use of such cleaning materials where possible.

In block 520, the processor of the cleaning robot may generate an instruction for the cleaning robot to schedule an operation of the cleaning robot. In some embodiments, the processor the cleaning robot may generate the instruction based on the determined timing, the determined frequency, the determined one or more locations for operation of the cleaning robot, and/or the intensity of the operation of the cleaning robot.

In block 410, the processor of the cleaning robot may execute the generated instruction to perform the operation of the cleaning robot, as described.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 400 and 500 may be substituted for or combined with one or more operations of the methods 400 and 500, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

What is claimed is:

1. A method of managing cleaning behavior by a cleaning robot, comprising:
obtaining, by a processor of a cleaning robot, information about one or more cleaning operations performed by the cleaning robot in one or more locations of a structure;
analyzing, by the processor, the information about the one or more cleaning operations in the one or more locations;
determining, by the processor, one or more cleaning parameters for the cleaning robot based on the analysis of the information about the one or more cleaning operations;
generating, by the processor, an instruction to schedule an operation of the cleaning robot based on the one or more cleaning parameters; and
executing, by the processor, the generated instruction to perform the operation of the cleaning robot.

2. The method of claim 1, wherein determining the one or more cleaning parameters for the cleaning robot based on the analysis of the information about the one or more cleaning operations comprises:
determining, by the processor, one or more physical characteristics of the one or more locations of the structure.

3. The method of claim 1, wherein determining the one or more cleaning parameters for the cleaning robot based on the analysis of the information about the one or more cleaning operations comprises:
determining, by the processor, a type of cleaning operations performed by the cleaning robot.

4. The method of claim 1, wherein determining the one or more cleaning parameters for the cleaning robot based on the analysis of the information about the one or more cleaning operations comprises:
determining, by the processor, an intensity of cleaning operations performed by the cleaning robot.

5. The method of claim 1, wherein determining the one or more cleaning parameters for the cleaning robot based on the analysis of the information about the one or more cleaning operations comprises:
determining, by the processor, a frequency of cleaning operations performed by the cleaning robot.

6. The method of claim 1, wherein generating an instruction for the cleaning robot to schedule an operation of the cleaning robot based on the one or more activity parameters comprises:
determining, by the processor, a timing for the operation of the cleaning robot based on the one or more cleaning parameters.

7. The method of claim 1, wherein generating an instruction for the cleaning robot to schedule an operation of the cleaning robot based on the one or more activity parameters comprises:
determining, by the processor, a frequency for the operation of the cleaning robot based on the one or more cleaning parameters.

8. The method of claim 1, wherein generating an instruction for the cleaning robot to schedule an operation of the cleaning robot based on the one or more activity parameters comprises:
determining, by the processor, one or more locations for the operation of the cleaning robot based on the one or more cleaning parameters.

9. The method of claim 1, wherein generating an instruction for the cleaning robot to schedule an operation of the cleaning robot based on the one or more activity parameters comprises:
determining, by the processor, an intensity for the operation of the cleaning robot based on the one or more cleaning parameters.

10. A cleaning robot, comprising:
a memory; and
a processor coupled to the memory and configured with processor-executable instructions to:
obtain information about one or more cleaning operations performed by the cleaning robot in one or more locations of a structure;
analyze the information about the one or more cleaning operations in the one or more locations;
determine one or more cleaning parameters for the cleaning robot based on the analysis of the information about the one or more cleaning operations;
generate an instruction to schedule an operation of the cleaning robot based on the one or more cleaning parameters; and
execute the generated instruction to perform the operation of the cleaning robot.

11. The cleaning robot of claim 10, wherein the processor is further configured with processor-executable instructions to:
determine one or more physical characteristics of the one or more locations of the structure.

12. The cleaning robot of claim 10, wherein the processor is further configured with processor-executable instructions to:
determine a type of cleaning operations performed by the cleaning robot.

13. The cleaning robot of claim 10, wherein the processor is further configured with processor-executable instructions to:
determine an intensity of cleaning operations performed by the cleaning robot.

14. The cleaning robot of claim 10, wherein the processor is further configured with processor-executable instructions to:
determine a frequency of cleaning operations performed by the cleaning robot.

15. The cleaning robot of claim 10, wherein the processor is further configured with processor-executable instructions to:
determine a timing for the operation of the cleaning robot based on the one or more cleaning parameters.

16. The cleaning robot of claim 10, wherein the processor is further configured with processor-executable instructions to:
determine a frequency for the operation of the cleaning robot based on the one or more cleaning parameters.

17. The cleaning robot of claim 10, wherein the processor is further configured with processor-executable instructions to:
determine one or more locations for the operation of the cleaning robot based on the one or more cleaning parameters.

18. The cleaning robot of claim 10, wherein the processor is further configured with processor-executable instructions to:
determine an intensity of the operation of the cleaning robot based on the one or more cleaning parameters.

19. A processing device for use in a cleaning robot configured to:
obtain information about one or more cleaning operations performed by the cleaning robot in one or more locations of a structure;
analyze the information about the one or more cleaning operations in the one or more locations;
determine one or more cleaning parameters for the cleaning robot based on the analysis of the information about the one or more cleaning operations;
generate an instruction to schedule an operation of the cleaning robot based on the one or more cleaning parameters; and
execute the generated instruction to perform the operation of the cleaning robot.

20. The processing device of claim 19, wherein the processing device is further configured to:
determine one or more physical characteristics of the one or more locations of the structure.

21. The processing device of claim 19, wherein the processing device is further configured to:
determine a type of cleaning operations performed by the cleaning robot.

22. The processing device of claim 19, wherein the processing device is further configured to:
determine an intensity of cleaning operations performed by the cleaning robot.

23. The processing device of claim 19, wherein the processing device is further configured to:
determine a frequency of cleaning operations performed by the cleaning robot.

24. The processing device of claim 19, wherein the processing device is further configured to:
determine a timing for the operation of the cleaning robot based on the one or more cleaning parameters.

25. The processing device of claim 19, wherein the processing device is further configured to:
determine a frequency for the operation of the cleaning robot based on the one or more cleaning parameters.

26. The processing device of claim 19, wherein the processing device is further configured to:
determine one or more locations for the operation of the cleaning robot based on the one or more cleaning parameters.

27. The processing device of claim 19, wherein the processing device is further configured to:
determine an intensity of the operation of the cleaning robot based on the one or more cleaning parameters.

28. A cleaning robot, comprising:
means for obtaining information about one or more cleaning operations performed by the cleaning robot in one or more locations of a structure;
means for analyzing the information about the one or more cleaning operations in the one or more locations;
means for determining one or more cleaning parameters for the cleaning robot based on the analysis of the information about the one or more cleaning operations;
means for generating an instruction to schedule an operation of the cleaning robot based on the one or more cleaning parameters; and
means for executing the generated instruction to perform the operation of the cleaning robot.

29. A non-transitory, processor-readable medium having stored thereon processor-executable instructions configured to cause a processor of a cleaning robot to perform operations comprising:
obtaining information about one or more cleaning operations performed by the cleaning robot in one or more locations of a structure;
analyzing the information about the one or more cleaning operations in the one or more locations;
determining one or more cleaning parameters for the cleaning robot based on the analysis of the information about the one or more cleaning operations;
generating an instruction to schedule an operation of the cleaning robot based on the one or more cleaning parameters; and
executing the generated instruction to perform the operation of the cleaning robot.
